(19) United States
(12) Patent Application Publication
(10) Pub. No.: US 2012/0050477 A1
(43) Pub. Date: Mar. 1, 2012

(54) Method and System for Utilizing Depth Information for Providing Security Monitoring

(76) Inventors: Jeyhan Karaoguz, Irvine, CA (US); Nambi Seshadri, Irvine, CA (US); Xuemin Chen, Rancho Santa Fe, CA (US); Chris Boross, Sunnyvale, CA (US)

(21) Appl. No.: 13/077,880

(22) Filed: Mar. 31, 2011

Related U.S. Application Data
(60) Provisional application No. 61/439,103, filed on Feb. 3, 2011.
(60) Provisional application No. 61/377,867, filed on Aug. 27, 2010.

(51) Int. Cl. H04N 13/02

(52) U.S. Cl. 348/46; 348/E13.074

(57) ABSTRACT

A monoscopic three-dimensional (3D) video generation device, which comprises one or more image sensors and one or more depth sensors, may be operable to capture a plurality of 2D video image frames of a scene via the one or more image sensors. The monoscopic 3D video generation device may concurrently capture corresponding depth information for the captured plurality of 2D video image frames, via the one or more depth sensors in the monoscopic 3D video generation device. The monoscopic 3D video generation device may be operable to analyze the captured plurality of 2D video image frames, based on the captured corresponding depth information, to provide security screening of one or more objects within the captured plurality of 2D video image frames. The security screening may comprise identifying, monitoring, and/or tracking of the one or more objects within the captured plurality of 2D video image frames.

### CROSS-REFERENCE TO RELATED APPLICATIONS/INCORPORATION BY REFERENCE

This patent application makes reference to, claims priority to, and claims benefit from:

U.S. Provisional Application Ser. No. 61/377,867, which was filed on Aug. 27, 2010; and
U.S. Provisional Application Ser. No. 61/439,103, which was filed on Feb. 3, 2011.

This application also makes reference to:

U.S. Patent Application Ser. No. 61/439,193 filed on Feb. 3, 2011;
U.S. patent application Ser. No. ______ (Attorney Docket No. 23461 US03) filed on Mar. 31, 2011;
U.S. Patent Application Ser. No. 61/439,274 filed on Feb. 3, 2011;
U.S. patent application Ser. No. ______ (Attorney Docket No. 23462US03) filed on Mar. 31, 2011;
U.S. Patent Application Ser. No. 61/439,283 filed on Feb. 3, 2011;
U.S. patent application Ser. No. ______ (Attorney Docket No. 23463US03) filed on Mar. 31, 2011;
U.S. Patent Application Ser. No. 61/439,130 filed on Feb. 3, 2011;
U.S. patent application Ser. No. ______ (Attorney Docket No. 23464US03) filed on Mar. 31, 2011;
U.S. Patent Application Ser. No. 61/439,290 filed on Feb. 3, 2011;
U.S. patent application Ser. No. ______ (Attorney Docket No. 23465US03) filed on Mar. 31, 2011;
U.S. Patent Application Ser. No. 61/439,119 filed on Feb. 3, 2011;
U.S. patent application Ser. No. ______ (Attorney Docket No. 23466US03) filed on Mar. 31, 2011;
U.S. Patent Application Ser. No. 61/439,297 filed on Feb. 3, 2011;
U.S. patent application Ser. No. ______ (Attorney Docket No. 23467US03) filed on Mar. 31, 2011;
U.S. Patent Application Ser. No. 61/439,201 filed on Feb. 3, 2011;
U.S. Patent Application Ser. No. 61/439,209 filed on Feb. 3, 2011;
U.S. Patent Application Ser. No. 61/439,113 filed on Feb. 3, 2011;
U.S. patent application Ser. No. ______ (Attorney Docket No. 23472US03) filed on Mar. 31, 2011;
U.S. Patent Application Ser. No. 61/439,083 filed on Feb. 3, 2011;
U.S. patent application Ser. No. ______ (Attorney Docket No. 23474US03) filed on Mar. 31, 2011;
U.S. Patent Application Ser. No. 61/439,301 filed on Feb. 3, 2011; and
U.S. patent application Ser. No. ______ (Attorney Docket No. 23475US03) filed on Mar. 31, 2011.

Each of the above stated applications is hereby incorporated herein by reference in its entirety.

### FIELD OF THE INVENTION

Certain embodiments of the invention relate to video processing. More specifically, certain embodiments of the invention relate to a method and system for utilizing depth information for providing security monitoring.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV (DTV), a 3D video is often desirable because it is often more realistic to viewers than the 2D counterpart. A 3D video comprises a left view video and a right view video.

Various video encoding standards, for example, MPEG-1, MPEG-2, MPEG-4, MPEG-C part 3, H.263, H.264/MPEG-4 advanced video coding (AVC), multi-view video coding (MVC) and scalable video coding (SVC), have been established for encoding digital video sequences in a compressed manner. For example, the MVC standard, which is an extension of the H.264/MPEG-4 AVC standard, may provide efficient coding of a 3D video. The SVC standard, which is also an extension of the H.264/MPEG-4 AVC standard, may enable transmission and decoding of partial bitstreams to provide video services with lower temporal or spatial resolutions or reduced fidelity, while retaining a reconstruction quality that is similar to that achieved using the H.264/MPEG-4 AVC.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for utilizing depth information for providing security monitoring, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram that illustrates an exemplary monoscopic 3D video camera embodying aspects of the present invention, compared with a conventional stereoscopic video camera.

FIG. 1B is a block diagram that illustrates exemplary processing of depth information and 2D color information to generate a 3D image, in accordance with an embodiment of the invention.

FIG. 2 is a block diagram illustrating an exemplary CCTV monitoring system that is operable to utilize depth information for providing security monitoring, in accordance with an embodiment of the invention.

FIG. 3 is a block diagram illustrating an exemplary monoscopic 3D video camera that is operable to utilize depth information for providing security monitoring, in accordance with an embodiment of the invention.

FIGS. 4A-4D are block diagrams that each illustrates exemplary security screening utilizing depth information, in accordance with an embodiment of the invention.

FIG. 5 is a flow chart illustrating exemplary steps for utilizing depth information for providing security monitoring, in accordance with an embodiment of the invention.

### DETAILED DESCRIPTION OF THE INVENTION

Certain embodiments of the invention can be found in a method and system for utilizing depth information for providing security monitoring. In various embodiments of the invention, a monoscopic three-dimensional (3D) video generation device, which comprises one or more image sensors and one or more depth sensors, may be operable to capture a plurality of two-dimensional (2D) video image frames of a scene via the one or more image sensors. The monoscopic 3D video generation device may concurrently capture, via the one or more depth sensors, corresponding depth information for the captured plurality of 2D video image frames. The captured plurality of 2D video image frames may be analyzed by the monoscopic 3D video generation device, based on the captured corresponding depth information, to provide security screening of one or more objects within the captured plurality of 2D video image frames. In this regard, the security screening may comprise, for example, identifying, monitoring, and/or tracking of the one or more objects within the captured plurality of 2D video image frames.

In an exemplary embodiment of the invention, the scene may comprise an object, and at least a portion of the object is covered by a shadow. In such instance, the monoscopic 3D video generation device may be operable to validate the security screening for the object for each of the captured plurality of 2D video image frames utilizing the captured corresponding depth information associated with the at least a portion of the object.

In an exemplary embodiment of the invention, the scene may comprise an object, and at least a portion of the object is in poor lighting environment. In such instance, the monoscopic 3D video generation device may be operable to validate the security screening for the object for each of the captured plurality of 2D video image frames utilizing the captured corresponding depth information associated with the at least a portion of the object.

In an exemplary embodiment of the invention, the scene may comprise an object that is facing toward a particular direction or is oriented in a particular direction. In such instance, the monoscopic 3D video generation device may be operable to perform the security screening for the object for each of the captured plurality of 2D video image frames, and identify the particular direction toward which the object is facing utilizing the captured corresponding depth information associated with the object.

In an exemplary embodiment of the invention, the scene may comprise an object that is moving toward a particular direction. In such instance, the monoscopic 3D video generation device may be operable to perform the security screening for the object for each of the captured plurality of 2D video image frames, and identify the particular direction toward which the object is moving utilizing the captured corresponding depth information associated with the object.

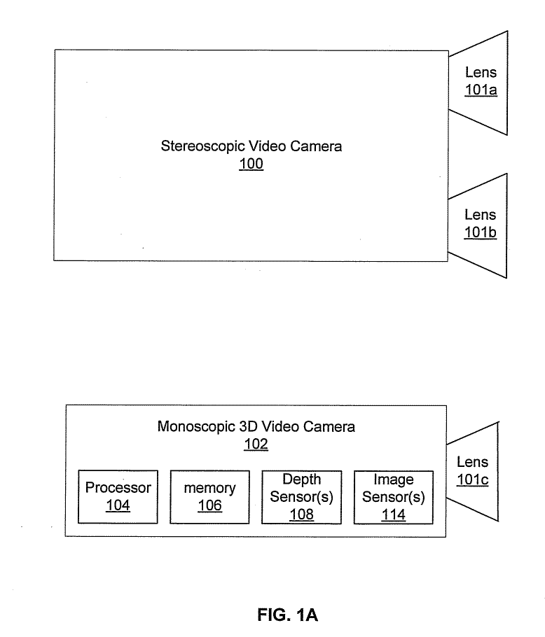

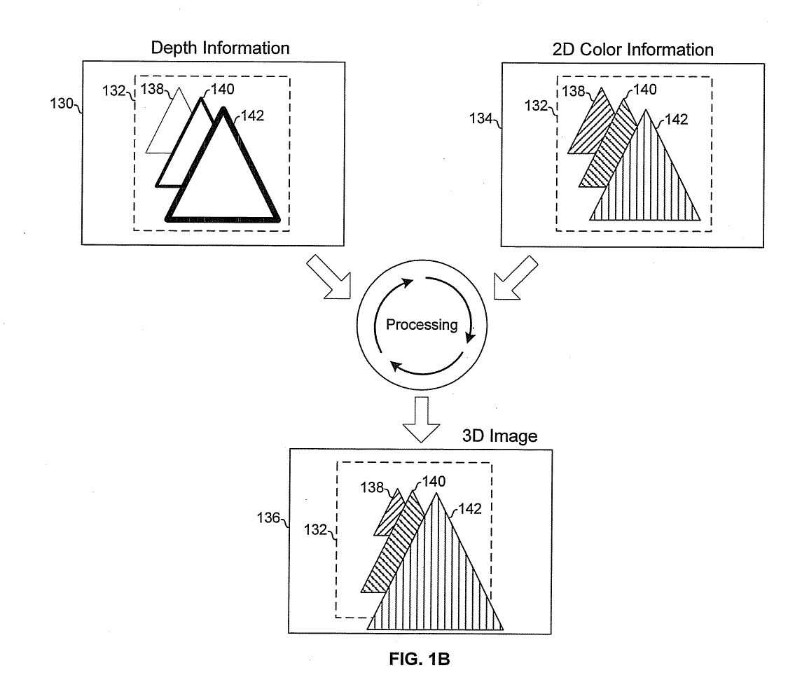

FIG. 1A is a block diagram that illustrates an exemplary monoscopic 3D video camera embodying aspects of the present invention, compared with a conventional stereoscopic video camera. Referring to FIG. 1A, there is shown a stereoscopic video camera 100 and a monoscopic 3D video camera 102. The stereoscopic video camera 100 may comprise two lenses 101a and 101b. Each of the lenses 101a and 101b may capture images from a different viewpoint and images captured via the two lenses 101a and 101b may be combined to generate a 3D image. In this regard, electromagnetic (EM) waves in the visible spectrum may be focused on a first one or more image sensors by the lens 101a (and associated optics) and EM waves in the visible spectrum may be focused on a second one or more image sensors by the lens (and associated optics) 101b.

The monoscopic 3D video camera 102 may comprise a processor 104, a memory 106, one or more depth sensors 108 and one or more image sensors 114. The monoscopic 3D or single-view video camera 102 may capture images via a single viewpoint corresponding to the lens 101c. In this regard, EM waves in the visible spectrum may be focused on one or more image sensors 114 by the lens 101c. The monoscopic 3D video camera 102 may also capture depth information via the lens 101c (and associated optics).

The processor 104 may comprise suitable logic, circuitry, interfaces, and/or code that may be operable to manage operation of various components of the monoscopic 3D video camera 102 and perform various computing and processing tasks.

The memory 106 may comprise, for example, DRAM, SRAM, flash memory, a hard drive or other magnetic storage, or any other suitable memory devices. For example, SRAM may be utilized to store data utilized and/or generated by the processor 104 and a hard-drive and/or flash memory may be utilized to store recorded image data and depth data.

The depth sensor(s) 108 may each comprise suitable logic, circuitry, interfaces, and/or code that may be operable to detect EM waves in the infrared spectrum and determine depth information based on reflected infrared waves. For example, depth information may be determined based on time-of-flight of infrared waves transmitted by an emitter (not shown) in the monoscopic 3D video camera 102 and reflected back to the depth sensor(s) 108. Depth information may also be determined using a structured light method, for example. In such instance, a pattern of light such as a grid of infrared waves may be projected at a known angle onto an object by a light source such as a projector. The depth sensor(s) 108 may detect the deformation of the light pattern such as the infrared light pattern on the object. Accordingly, depth information for a scene may be determined or calculated using, for example, a triangulation technique.

The image sensor(s) 114 may each comprise suitable logic, circuitry, interfaces, and/or code that may be operable to convert optical signals to electrical signals. Each image sensor 114 may comprise, for example, a charge coupled device (CCD) image sensor or a complimentary metal oxide semiconductor (CMOS) image sensor. Each image sensor 114 may capture brightness, luminance and/or chrominance information.

In exemplary operation, the monoscopic 3D video camera 102 may be utilized in a closed-circuit television (CCTV) monitoring system. The monoscopic 3D video camera 102 may be operable to capture a plurality of 2D video image frames and corresponding depth information of a scene utilizing the image sensor(s) 114 and the depth sensor(s) 108 respectively. The processor 104 may be operable to analyze the captured plurality of 2D video image frames, based on the captured corresponding depth information, for providing security screening of one or more objects within the captured plurality of 2D video image frames. In this regard, the security screening may comprise, for example, object detection, object recognition, object tracking and/or motion detection for the one or more objects.

FIG. 1B is a block diagram that illustrates exemplary processing of depth information and 2D color information to generate a 3D image, in accordance with an embodiment of the invention. Referring to FIG. 1B, there is shown a frame of depth information 130, a frame of 2D color information 134 and a frame of 3D image 136. The frame of depth information 130 may be captured by the depth sensor(s) 108 and the frame of 2D color information 134 may be captured by the image sensor(s) 114. The frame of depth information 130 may be utilized while processing the frame of 2D color information 134 by the processor 104 to generate the frame of 3D image 136. The dashed line 132 may indicate a reference plane to illustrate the 3D image. In the frame of depth information 130, a line weight is used to indicate depth. In this regard, for example, the heavier the line, the closer that portion of the frame 130 is to a monoscopic 3D video camera 102. Therefore, the object 138 is farthest from the monoscopic 3D video camera 102, the object 142 is closest to the monoscopic 3D video camera, and the object 140 is at an intermediate depth. In various embodiments of the invention, the depth information may be mapped to a grayscale or pseudo-grayscale image by the processor 104.

The image in the frame 134 is a conventional 2D image. A viewer of the frame 134 perceives the same depth between the viewer and each of the objects 138, 140 and 142. That is, each of the objects 138, 140, 142 appears to reside on the reference plane 132. The image in the frame 136 is a 3D image. A viewer of the frame 136 perceives the object 138 being further from the viewer, the object 142 being closest to the viewer, and the object 140 being at an intermediate depth. In this regard, the object 138 appears to be behind the reference plane 132, the object 140 appears to be on the reference plane 132, and the object 142 appears to be in front of the reference plane 132.

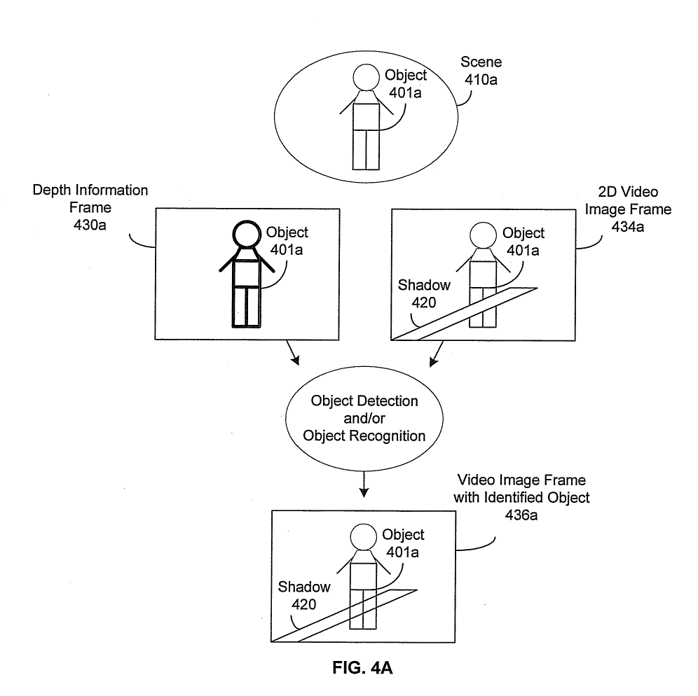

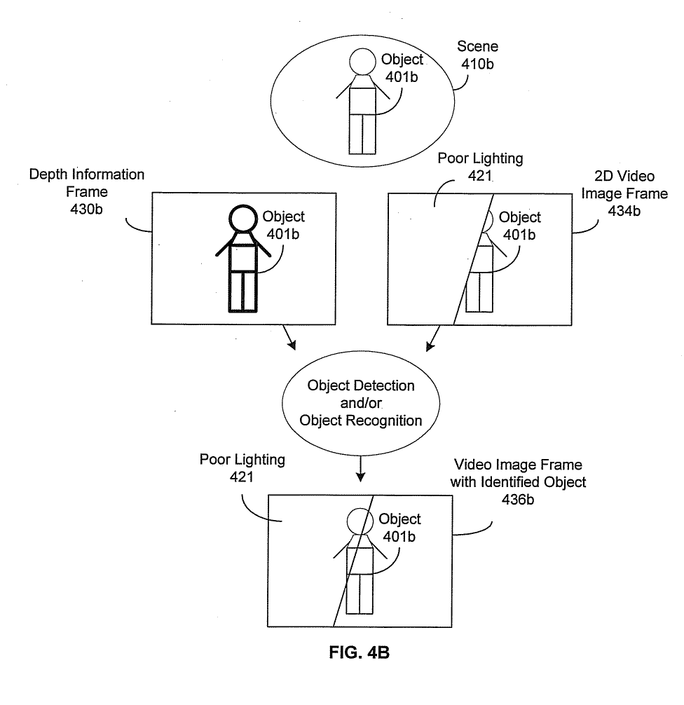

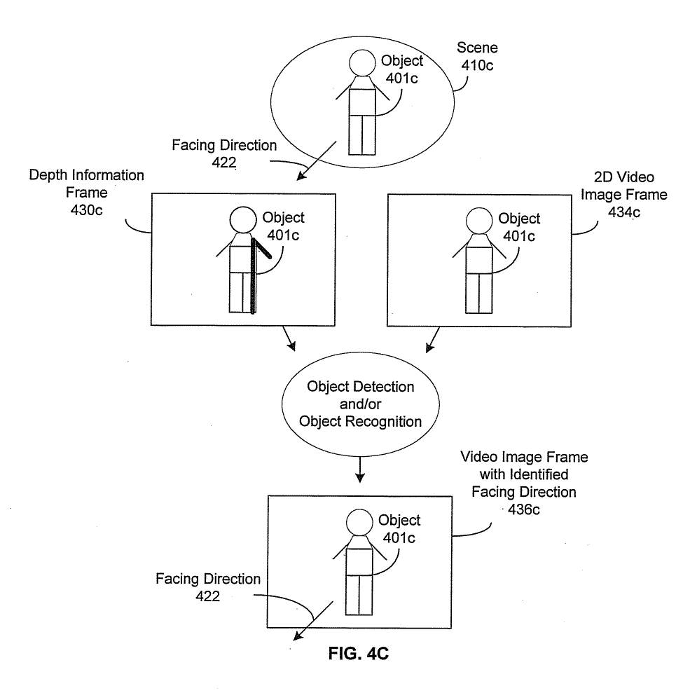

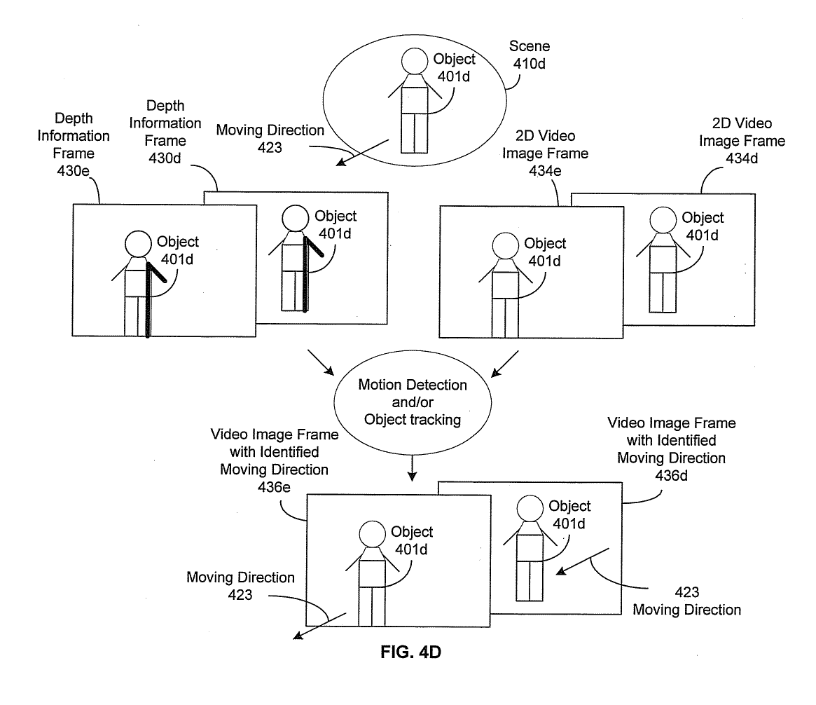

In an exemplary embodiment of the invention, in addition to generating the frame of 3D image 136, the processor 104 may also be operable to perform security screening such as, for example, object detection, object recognition, object tracking and/or motion detection for the frame of 2D color information 134, and utilize the frame of depth information 130 to improve or enhance the performance of the security screening. Exemplary security screening utilizing the depth information may be described below with respect to FIGS. 4A-4D.

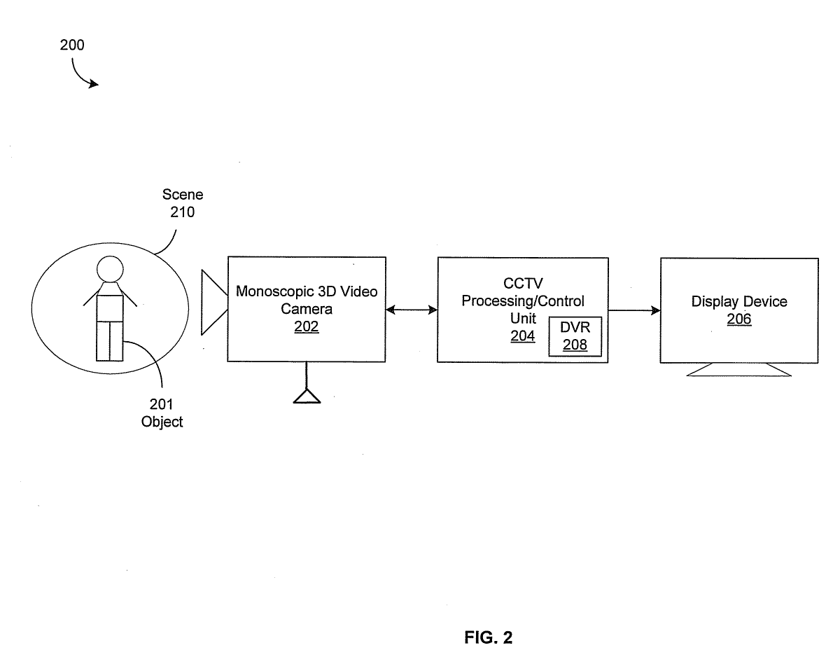

FIG. 2 is a block diagram illustrating an exemplary CCTV monitoring system that is operable to utilize depth information for providing security monitoring, in accordance with an embodiment of the invention. Referring to FIG. 2, there is shown a closed-circuit television (CCTV) monitoring system 200. The CCTV monitoring system 200 may comprise a monoscopic 3D video camera 202, a CCTV processing/control unit 204 and a display device 206.

The monoscopic 3D video camera 202 may comprise suitable logic, circuitry, interfaces and/or code that may be operable to capture 2D video image frames and corresponding depth information of a scene such as the scene 210. The scene 210 may comprise an object such as the object 201. The monoscopic 3D video camera 202 may be substantially similar to the monoscopic 3D video camera 102 in FIG. 1A. In an exemplary embodiment of the invention, the monoscopic 3D video camera 202 may be operable to provide security screening of the object 201 within the captured 2D video image frames, and analyze the captured 2D video image frames based on the captured corresponding depth information so as to improve the performance of the security screening. In this regard, the security screening may comprise, for example, object detection, object recognition, object tracking, motion detection associated with the object 201 in the scene 210. The monoscopic 3D video camera 202 may communicate the captured 2D video images frames, the captured corresponding depth information and/or results of the performed VCA functions to the CCTV processing/control unit 204.

The CCTV processing/control unit 204 may comprise suitable logic, circuitry, interfaces and/or code that may be operable to perform various CCTV functions such as processing video image data and/or other information generated by the monoscopic 3D video camera 202, controlling the operation of the monoscopic 3D video camera 202 and/or recording captured video image data. The CCTV processing/control unit 204 may comprise, for example, a PC or a server. The CCTV processing/control unit 204 may provide recording function, utilizing a digital video recorder (DVR) 208 for recording video images which may be captured and/or generated by the monoscopic 3D video camera 202. The CCTV processing/control unit 204 may provide control functions to the monoscopic 3D video camera 202. For example, when an object tracking function is performed by the monoscopic 3D video camera 202, the CCTV processing/control unit 204 may communicate control signals to the monoscopic 3D video camera 202 for tracking an identified moving object such as an identified moving person. The CCTV processing/control unit 204 may communicate with the display device 206 for displaying or presenting video images, which may be captured and/or generated by the monoscopic 3D video camera 202, and/or playing back video images, which may be recorded by the DVR 208.

The display device 206 may comprise suitable logic, circuitry, interfaces and/or code that may be operable to display or present captured video images and/or recorded video images.

In operation, the monoscopic 3D video camera 202 may be operable to monitor a scene such as the scene 210 in a CCTV monitoring system 200. The monoscopic 3D video camera 202 may capture a plurality of 2D video image frames and corresponding depth information of the scene 210. The scene 210 may comprise the object 201. For example, the scene 210 may be an area inside a store and the object 201 in the scene 210 may be a targeted person within the store. The monoscopic 3D video camera 202 may be operable, to analyze the captured plurality of 2D video image frames of the scene 210, based on the captured corresponding depth information so as to provide security screening of the object 201 within the captured plurality of 2D video image frames. The monoscopic 3D video camera 202 may perform the security screening utilizing, for example, object detection, object recognition, object tracking, and/or motion detection associated with the object 201.

The object detection may be used to determine the presence of a type of object or entity, for example, a person or a car in the scene 210. The object recognition may be used to recognize, and therefore identify an object such as a person or a car in the scene 210. The object recognition may comprise, for example, face recognition and/or automatic number plate recognition. The object tracking may be used to determine the location of an object such as a person or a car in the video image, possibly with regard to an external reference grid or point. The motion detection may be used to determine the presence of relevant motion of an object such as the object 201 in the scene 210.

In an exemplary embodiment of the invention, one or more portions of the object 201 in the scene 210 may be covered by a shadow. In such an instance, the monoscopic 3D video camera 202 may be operable to validate the security screening for the object 201 for each of the captured plurality of 2D video image frames, utilizing the captured corresponding depth information associated with the covered portion(s) of the object 201. In this regard, for example, the monoscopic 3D video camera 202 may perform the object detection or the object recognition for the captured 2D video image frames. Due to the shadow covering one or more portions of the object 201, the image of the object 201 may appear to be incomplete or insufficient for such object detection or object recognition. In this regard, the object detection or the object recognition may be enhanced by validating or confirming the image of the object 201 utilizing the captured corresponding depth information which may be associated with the covered one or more portions of the object 201.

In an exemplary embodiment of the invention, certain portion of the object 201 in the scene 210 may be in poor lighting environment. The poor lighting condition may be due to, for example, changes in lighting. In such an instance, the monoscopic 3D video camera 202 may be operable to utilize the captured corresponding depth information that is associated with the certain portion of the object 201, which is in the poor lighting environment, to validate the security screening for the object 201 for each of the captured plurality of 2D video image frames. In this regard, for example, the monoscopic 3D video camera 202 may perform the object detection or the object recognition for the captured 2D video image frames. Due to one or more portions of the object 201 being in poor lighting environment, the image of the object 201 may appear to be incomplete or insufficient for such object detection or object recognition. In this regard, the object detection or the object recognition may be enhanced by validating or confirming the image of the object 201 utilizing the captured corresponding depth information which may be associated with the poor-lighting or dark portion of the object 201.

In an exemplary embodiment of the invention, the object 201 in the scene 210 may be facing toward a particular direction or oriented in a particular direction. In such an instance, while performing the security screening for the object 201 for each of the captured plurality of 2D video image frames, the monoscopic 3D video camera 202 may identify the particular direction toward which the object 201 is facing, utilizing the captured corresponding depth information associated with the object 201. In this regard, for example, the monoscopic 3D video camera 202 may perform the object detection or the object recognition for the captured 2D video image frames. Based on the depth information associated with different portions of the detected or identified object 201, the particular direction toward which the object 201 is facing may be identified.

In an exemplary embodiment of the invention, the object 201 in the scene 210 may be moving toward a particular direction. In such an instance, while performing the security screening for the object 201 for each of the captured plurality of 2D video image frames, the monoscopic 3D video camera 202 may identify the particular direction toward which the object 201 is moving, utilizing the captured corresponding depth information associated with the object 201. In this regard, for example, the monoscopic 3D video camera 202 may perform the motion detection or the object tracking for the captured 2D video image frames. Based on the depth information associated with different portions of the detected moving object 201, the particular direction toward which the object 201 is moving may be identified.

The monoscopic 3D video camera 202 may be operable to communicate the captured 2D video image frames, the captured corresponding depth information and/or results of the performed security screening to the CCTV processing/control unit 204 for further processing such as, for example, recording and/or display.

Although a monoscopic 3D video camera 202 is illustrated in FIG. 2, the invention may not be so limited. Accordingly, other monoscopic 3D video generation device which generates 3D video content in 2D-plus-depth formats may be illustrated without departing from the spirit and scope of various embodiments of the invention.

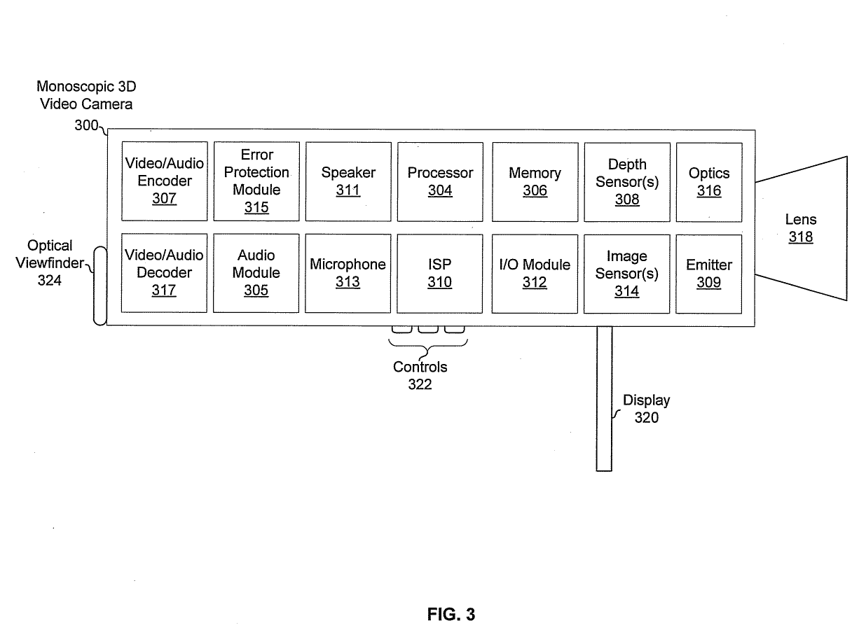

FIG. 3 is a block diagram illustrating an exemplary monoscopic 3D video camera that is operable to utilize depth information for providing security monitoring, in accordance with an embodiment of the invention. Referring to FIG. 3, there is shown a monoscopic 3D video camera 300. The monoscopic 3D video camera 300 may comprise a processor 304, a memory 306, one or more depth sensors 308, an emitter 309, an image signal processor (ISP) 310, an input/output (I/O) module 312, one or more image sensors 314, an optics 316, a speaker 311, a microphone 313, a video/audio encoder 307, a video/audio decoder 317, an audio module 305, an error protection module 315, a lens 318, a plurality of controls 322, an optical viewfinder 324 and a display 320. The monoscopic 3D video camera 300 may be substantially similar to the monoscopic 3D video camera 102 in FIG. 1A.

The processor 304 may comprise suitable logic, circuitry, interfaces, and/or code that may be operable to coordinate operation of various components of the monoscopic 3D video camera 300. The processor 304 may, for example, run an operating system of the monoscopic 3D video camera 300 and control communication of information and signals between components of the monoscopic 3D video camera 300. The processor 304 may execute code stored in the memory 306.

In an exemplary embodiment of the invention, the processor 304 may perform security screening such as, for example, object detection, object recognition, object tracking and/or motion detection, for each of captured 2D video image frames of a scene such as the scene 210. The processor 304 may utilize captured corresponding depth information to enhance the performing of the security screening.

The memory 306 may comprise, for example, DRAM, SRAM, flash memory, a hard drive or other magnetic storage, or any other suitable memory devices. For example, SRAM may be utilized to store data utilized and/or generated by the processor 304 and a hard-drive and/or flash memory may be utilized to store recorded image data and depth data.

The depth sensor(s) 308 may each comprise suitable logic, circuitry, interfaces, and/or code that may be operable to detect EM waves in the infrared spectrum and determine depth information based on reflected infrared waves. For example, depth information may be determined based on time-of-flight of infrared waves transmitted by the emitter 309 and reflected back to the depth sensor(s) 308. Depth information may also be determined using a structured light method, for example. In such instance, a pattern of light such as a grid of infrared waves may be projected at a known angle onto an object by a light source such as a projector. The depth sensor(s) 308 may detect the deformation of the light pattern such as the infrared light pattern on the object. Accordingly, depth information for a scene may be determined or calculated using, for example, a triangulation technique.

The image signal processor or image sensor processor (ISP) 310 may comprise suitable logic, circuitry, interfaces, and/or code that may be operable to perform complex processing of captured image data and captured corresponding depth data. The ISP 310 may perform a plurality of processing techniques comprising, for example, filtering, demosaic, Bayer interpolation, lens shading correction, defective pixel correction, white balance, image compensation, color transformation and/or post filtering.

The audio module 305 may comprise suitable logic, circuitry, interfaces and/or code that may be operable to perform various audio functions of the monoscopic 3D video camera 300. In an exemplary embodiment of the invention, the audio module 305 may perform noise cancellation and/or audio volume level adjustment for a 3D scene.

The video/audio encoder 307 may comprise suitable logic, circuitry, interfaces and/or code that may be operable to perform video encoding and/or audio encoding functions. For example, the video/audio encoder 307 may encode or compress captured 2D video images and corresponding depth information and/or audio data for transmission.

The video/audio decoder 317 may comprise suitable logic, circuitry, interfaces and/or code that may be operable to perform video decoding and/or audio decoding functions.

The error protection module 315 may comprise suitable logic, circuitry, interfaces and/or code that may be operable to perform error protection functions for the monoscopic 3D video camera 300. For example, the error protection module 315 may provide error protection to encoded 2D video images and corresponding depth information and/or encoded audio data for transmission.

The input/output (I/O) module 312 may comprise suitable logic, circuitry, interfaces, and/or code that may enable the monoscopic 3D video camera 300 to interface with other devices in accordance with one or more standards such as USB, PCI-X, IEEE 1394, HDMI, DisplayPort, and/or analog audio and/or analog video standards. For example, the I/O module 312 may be operable to send and receive signals from the controls 322, output video to the display 320, output audio to the speaker 311, handle audio input from the microphone 313, read from and write to cassettes, flash cards, solid state drives, hard disk drives or other external memory attached to the monoscopic 3D video camera 300, and/or output audio and/or video externally via one or more ports such as a IEEE 1394 port, a HDMI and/or an USB port for transmission and/or rendering. In an exemplary embodiment of the invention, the monoscopic 3D video camera 300 may communication with a CCTV processing/control unit such as the CCTV processing/control unit 204 via the I/O module 312.

The image sensor(s) 314 may each comprise suitable logic, circuitry, interfaces, and/or code that may be operable to convert optical signals to electrical signals. Each image sensor 314 may comprise, for example, a charge coupled device (CCD) image sensor or a complimentary metal oxide semiconductor (CMOS) image sensor. Each image sensor 314 may capture brightness, luminance and/or chrominance information.

The optics 316 may comprise various optical devices for conditioning and directing EM waves received via the lens 318. The optics 316 may direct EM waves in the visible spectrum to the image sensor(s) 314 and direct EM waves in the infrared spectrum to the depth sensor(s) 308. The optics 316 may comprise, for example, one or more lenses, prisms, luminance and/or color filters, and/or mirrors.

The lens 318 may be operable to collect and sufficiently focus electromagnetic (EM) waves in the visible and infrared spectra.

The display 320 may comprise a LCD display, a LED display, an organic LED (OLED) display and/or other digital display on which images recorded via the monoscopic 3D video camera 300 may be displayed. In an embodiment of the invention, the display 320 may be operable to display 3D images.

The controls 322 may comprise suitable logic, circuitry, interfaces, and/or code that may enable a user to interact with the monoscopic 3D video camera 300. For example, the controls 322 may enable the user to control recording and playback. The controls 322 may enable the user to select whether the monoscopic 3D video camera 300 operates in 2D mode or 3D mode.

The optical viewfinder 324 may enable a user to view or see what the lens 318 “sees,” that is, what is “in frame”.

In operation, the image sensor(s) 314 may capture brightness, luminance and/or chrominance information associated with 2D video image frames and the depth sensor(s) 308 may capture corresponding depth information. In various embodiments of the invention, various color formats, such as RGB and YCrCb, may be utilized. The processor 304 may be operable to perform security screening such as, for example, object detection, object recognition, object tracking and/or motion detection, for each of the captured 2D video image frames of the scene 210. The processor 304 may utilize captured corresponding depth information to analyze the captured 2D video image frames for enhancing identifying, monitoring, and/or tracking of one or more objects in the scene 210 such as the object 201. In this regard, for example, the object 201 may be a person.

In an exemplary embodiment of the invention, a certain portion of the object 201 in the scene 210 may be covered by a shadow. In such an instance, the processor 304 may validate the performing of the security screen for the object 201 for each of the captured 2D video image frames, utilizing the captured corresponding depth information associated with the covered portion of the object 201. For example, the processor 304 may perform the object detection or the object recognition for the captured 2D video image frames. Due to the shadow covering a certain portion of the object 201, the image of the object 201 may appear to be incomplete or insufficient for such object detection or object recognition. In this regard, the processor 304 may enhance the object detection or the object recognition by validating or confirming the image of the object 201 utilizing the captured corresponding depth information associated with the covered certain portion of the object 201.

In an exemplary embodiment of the invention, the object 201 in the scene 210 may comprise a certain portion which may be in poor lighting environment or poorly illuminated. In such an instance, the processor 304 may utilize the captured corresponding depth information associated with the poorly illuminated portion of the object 20 to validate the performing of the security screening for the object 201 for each of the 2D video image frames. For example, the processor 304 may perform the object detection or the object recognition for the captured 2D video image frames. Due to a certain portion of the object 201 being in poor lighting environment, the image of the object 201 may appear to be incomplete or insufficient for such object detection or object recognition. In this regard, the processor 304 may enhance the object detection or the object recognition by validating or confirming the image of the object 201 utilizing the captured corresponding depth information associated with the poorly illuminated or dark portion of the object 201.

In an exemplary embodiment of the invention, the object 201 in the scene 210 may be facing toward a particular direction or oriented in a particular direction. In such instance, while performing the security screening for the object 201 for each of the captured 2D video image frames, the processor 304 may identify the particular direction toward which the object 201 is facing, utilizing the captured corresponding depth information associated with the object 201. For example, the processor 304 may perform the object detection or the object recognition for the captured 2D video image frames. Based on the depth information associated with different portions of the detected or identified object 201, the particular direction toward which the object 201 is facing may be identified by the processor 304.

In an exemplary embodiment of the invention, the object 201 in the scene 210 may be a moving object which is moving toward a particular direction. In such instance, while performing the security screening for the object 201 for each of the captured 2D video image frames, the processor 304 may identify the particular direction toward which the object 201 is moving, utilizing the captured corresponding depth information associated with the object 201. For example, the processor 304 may perform the motion detection or the object tracking for the captured 2D video image frames. Based on the depth information associated with different portions of the detected moving object 201, the particular direction toward which the object 201 is moving may be identified by the processor 304.

FIGS. 4A-4D are block diagrams that each illustrates exemplary security screening utilizing depth information, in accordance with an embodiment of the invention. These scenarios are provided by way of exemplary illustration and not of limitation.

FIG. 4A illustrates a first exemplary scenario of security screening utilizing depth information. Referring to FIG. 4A, there is shown a scene 410a, a 2D video image frame 434a, a depth information frame 430a and a video image frame with identified object 436a. The scene 410a may comprise an object 401a. The 2D video image frame 434a and the depth information frame 430a may be captured by a monoscopic 3D video camera such as the monoscopic 3D video camera 300. In this regard, the 2D video image frame 434a may be captured by the image sensor(s) 314 and the depth information frame 430a may be captured by the depth sensor(s) 308. In the depth information frame 430a, a line weight is used to indicate depth as described above with respect to FIG. 1B. In this exemplary scenario, a certain portion of the object 401a is covered by a shadow 420 as illustrated in the 2D video image frame 434a. The processor 304 in the monoscopic 3D video camera 300 may perform security screening such as object detection and/or object recognition for the 2D video image frame 434a. Due to the shadow 420 covering a certain portion of the object 401a, the image of the object 401a may appear to be incomplete or insufficient, as illustrated in the 2D video image frame 434a, for such object detection or object recognition. In this regard, the depth information associated with the covered certain portion of the object 401a in the depth information frame 430a may be utilized by the object detection or the object recognition to validate or confirm the identity of the image of the object 401a. Accordingly, the object 401a may be detected or recognized as illustrated in the video image frame with identified object 436a.

FIG. 4B illustrates a second exemplary scenario of security screening utilizing depth information. Referring to FIG. 4B, there is shown a scene 410b, a 2D video image frame 434b, a depth information frame 430b and a video image frame with identified object 436b. The scene 410b may comprise an object 401b. The 2D video image frame 434b and the depth information frame 430b may be captured by a monoscopic 3D video camera such as the monoscopic 3D video camera 300. In this regard, the 2D video image frame 434b may be captured by the image sensor(s) 314 and the depth information frame 430b may be captured by the depth sensor(s) 308. In the depth information frame 430b, a line weight is used to indicate depth as described above with respect to FIG. 1B. In this exemplary scenario, a certain portion of the object 401b is poorly lit or poorly illuminated as illustrated by the poor lighting 421 in the 2D video image frame 434b. The processor 304 in the monoscopic 3D video camera 300 may perform security screening such as object detection and/or object recognition for the 2D video image frame 434b. Due to the poor lighting 421, the image of the object 401b may appear to be incomplete or insufficient, as illustrated in the 2D video image frame 434b, for such object detection or object recognition. In this regard, the depth information associated with the poorly illuminated portion of the object 401b in the depth information frame 430b may be utilized by the object detection or the object recognition to validate or confirm an identity or nature of the image of the object 401b. Accordingly, the object 401b may be detected or recognized as illustrated in the video image frame with identified object 436b.

FIG. 4C illustrates a third exemplary scenario of security screening utilizing depth information. Referring to FIG. 4C, there is shown a scene 410c, a 2D video image frame 434c, a depth information frame 430c and a video image frame with identified facing direction 436c. The scene 410c may comprise an object 401c. The 2D video image frame 434c and the depth information frame 430c may be captured by a monoscopic 3D video camera such as the monoscopic 3D video camera 300. In this regard, the 2D video image frame 434c may be captured by the image sensor(s) 314 and the depth information frame 430c may be captured by the depth sensor(s) 308. In the depth information frame 430c, a line weight is used to indicate depth as described above with respect to FIG. 1B. In this exemplary scenario, the object 401c in the scene 410c is facing toward a particular direction or is oriented in a particular direction as illustrated by the facing direction 422. The processor 304 in the monoscopic 3D video camera 300 may perform security screening such as object detection and/or object recognition for the 2D video image frame 434c. In this regard, the particular direction toward which the detected or recognized object 401c is facing may be identified based on the depth information associated with different portions of the object 401c in the depth information frame 430c. Accordingly, the facing direction 422 may be identified as illustrated in the video image frame with identified facing direction 436c.

FIG. 4D illustrates a fourth exemplary scenario of security screening utilizing depth information. Referring to FIG. 4D, there is shown a scene 410d, a plurality of 2D video image frames of which frames 434d, 434e are illustrated, a plurality of corresponding depth information frames of which frames 430d, 430e are illustrated and a plurality of video image frames with identified moving direction, of which frames 436d, 436e are illustrated. The scene 410d may comprise an object 401d. The 2D video image frames 434d, 434e and the depth information frames 430d, 430e may be captured by a monoscopic 3D video camera such as the monoscopic 3D video camera 300. In this regard, the 2D video image frames 434d, 434e may be captured by the image sensor(s) 314 and the depth information frames 430d, 430e may be captured by the depth sensor(s) 308. In each of the depth information frames 430d, 430e, a line weight is used to indicate depth as described above with respect to FIG. 1B. In this exemplary scenario, the object 401d in the scene 410d is moving toward a particular direction as illustrated by the moving direction 423. The processor 304 in the monoscopic 3D video camera 300 may perform security screening such as motion detection and/or object tracking for the 2D video image frames 434d, 434e. In this regard, the particular direction toward which the detected object 401d is moving may be identified based on the depth information associated with different portions of the object 401d in each of the depth information frames 430d, 430e. Accordingly, the moving direction 423 may be identified as illustrated in the video image frames with identified moving direction 436d, 436e.

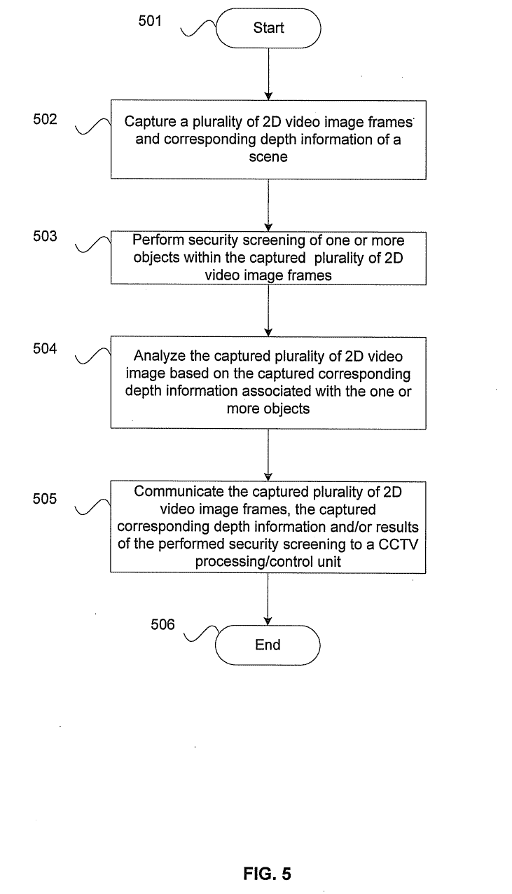

FIG. 5 is a flow chart illustrating exemplary steps for utilizing depth information for providing security monitoring, in accordance with an embodiment of the invention. Referring to FIG. 5, the exemplary steps start at step 501. In step 502, the monoscopic 3D video camera 300 may be operable to capture a plurality of 2D video image frames and corresponding depth information of a scene such as the scene 210, utilizing the image sensor(s) 314 and the depth sensor(s) 308, respectively. In step 503, the processor 304 in the monoscopic 3D video camera 300 may perform security screening of one or more objects such as the object 201 within the captured plurality of 2D video image frames. The security screening may comprise, for example, object detection, object recognition, object tracking, and/or motion detection. In step 504, the processor 304 may analyze the captured plurality of 2D video image frames based on the captured corresponding depth information associated with the one or more objects such as the object 201. For example, the corresponding depth information may be utilized to validate the detection or the recognition of an object such as the object 201, where at least a portion of the object 201 is covered by a shadow or is in poor lighting environment. The corresponding depth information may also be utilized to identify a particular direction toward which an object such as the object 201 is facing or moving, for example. In step 505, the monoscopic 3D video camera 300 may communicate, via the I/O module 312, the captured plurality of 2D video image frames, the captured corresponding depth information and/or results of the performed security screening to a CCTV processing/control unit such as the CCTV processing/control unit 204. The exemplary steps may proceed to the end step 506.

In various embodiments of the invention, a monoscopic 3D video generation device such as the monoscopic 3D video camera 300 may comprise one or more image sensors 314 and one or more depth sensors 308. The monoscopic 3D video camera 300 may be operable to capture a plurality of 2D video image frames of a scene such as the scene 210 via the one or more image sensors 314. The monoscopic 3D video camera 300 may concurrently capture, via the one or more depth sensors 308, corresponding depth information for captured plurality of 2D video image frames. A processor 304 in the monoscopic 3D video camera 300 may be operable to analyze the captured plurality of 2D video image frames based on the captured corresponding depth information, for providing security screening of one or more object such as the object 201 within the captured plurality of 2D video image frames. The security screening may comprise, for example, identifying, monitoring, and/or tracking of the one or more objects such as the object 201 within the captured plurality of 2D video image frames.

In an exemplary embodiment of the invention, a scene such as the scene 410a may comprise an object such as the object 401a, and at least a portion of the object 401a is covered by a shadow such as the shadow 420. In such instance, the processor 304 may validate the security screening for the object 401a for each of the captured plurality of 2D video image frames such as the 2D video image frame 434a, utilizing the captured corresponding depth information 430a associated with the at least a portion of the object 401a.

In an exemplary embodiment of the invention, a scene such as the scene 410b may comprise an object such as the object 401b, and at least a portion of the object 401b is in poor lighting environment such as in the poor lighting area 421. In such instance, the processor 304 may validate the security screening for the object 401b for each of the captured plurality of 2D video image frames such as the 2D video image frame 434b, utilizing the captured corresponding depth information 430b associated with the at least a portion of the object 401b.

In an exemplary embodiment of the invention, a scene such as the scene 410c may comprise an object such as the object 401c that is facing toward a particular direction or is oriented in a particular direction, such as the facing direction 422. In such instance, the processor 304 may perform the security screening for the object 401c for each of the captured plurality of 2D video image frames such as the 2D video image frame 434c, and identify the facing direction 422 utilizing the captured corresponding depth information 430c associated with the object 401c.

In an exemplary embodiment of the invention, a scene such as the scene 410d may comprise an object such as the object 401d that is moving toward a particular direction such as the moving direction 423. In such instance, the processor 304 may perform the security screening for the object 401d for each of the captured plurality of 2D video image frames such as the 2D video image frames 434d, 434e, and identify the moving direction 423 utilizing the captured corresponding depth information 430d, 430e associated with the object 401d.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for utilizing depth information for providing security monitoring.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video, the method comprising:
in a monoscopic three-dimensional (3D) video generation device comprising one or more image sensors and one or more depth sensors:
capturing a plurality of 2D video image frames of a scene via said one or more image sensors;
concurrently capturing via said one or more depth sensors, corresponding depth information for said captured plurality of 2D video image frames; and
analyzing said captured plurality of 2D video image frames, based on said captured corresponding depth information, to provide security screening of one or more objects within said captured plurality of 2D video image frames.

2. The method according to claim 1, wherein said security screening comprises identifying, monitoring, and/or tracking of said one or more objects within said captured plurality of 2D video image frames.

3. The method according to claim 1, wherein said scene comprises an object, and at least a portion of said object is covered by a shadow.

4. The method according to claim 3, comprising validating said security screening for said object for each of said captured plurality of 2D video image frames utilizing said captured corresponding depth information associated with said at least a portion of said object.

5. The method according to claim 1, wherein said scene comprises an object, and at least a portion of said object is in poor lighting environment.

6. The method according to claim 5, comprising validating said security screening for said object for each of said captured plurality of 2D video image frames utilizing said captured corresponding depth information associated with said at least a portion of said object.

7. The method according to claim 1, wherein said scene comprises an object that is facing toward a particular direction.

8. The method according to claim 7, comprising:
performing said security screening for said object for each of said captured plurality of 2D video image frames; and
identifying said particular direction toward which said object is facing utilizing said captured corresponding depth information associated with said object.

9. The method according to claim 1, wherein said scene comprises an object that is moving toward a particular direction.

10. The method according to claim 9, comprising:
performing said security screening for said object for each of said captured plurality of 2D video image frames; and
identifying said particular direction toward which said object is moving utilizing said captured corresponding depth information associated with said object.

11. A system for processing video, the system comprising:
one or more processors and/or circuits for use in a monoscopic three-dimensional (3D) video generation device comprising one or more image sensors and one or more depth sensors, wherein said one or more processors and/or circuits are operable to:
capture a plurality of 2D video image frames of a scene via said one or more image sensors;
concurrently capture via said one or more depth sensors, corresponding depth information for said captured plurality of 2D video image frames; and
analyze said captured plurality of 2D video image frames, based on said captured corresponding depth information, to provide security screening of one or more objects within said captured plurality of 2D video image frames.

12. The system according to claim 11, wherein said security screening comprises identifying, monitoring, and/or tracking of said one or more objects within said captured plurality of 2D video image frames.

13. The system according to claim 11, wherein said scene comprises an object, and at least a portion of said object is covered by a shadow.

14. The system according to claim 13, wherein said one or more processors and/or circuits are operable to validate said security screening for said object for each of said captured plurality of 2D video image frames utilizing said captured corresponding depth information associated with said at least a portion of said object.

15. The system according to claim 11, wherein said scene comprises an object, and at least a portion of said object is in poor lighting environment.

16. The system according to claim 15, wherein said one or more processors and/or circuits are operable to validate said security screening for said object for each of said captured plurality of 2D video image frames utilizing said captured corresponding depth information associated with said at least a portion of said object.

17. The system according to claim 11, wherein said scene comprises an object that is facing toward a particular direction.

18. The system according to claim 17, wherein said one or more processors and/or circuits are operable to:
perform said security screening for said object for each of said captured plurality of 2D video image frames; and
identify said particular direction toward which said object is facing utilizing said captured corresponding depth information associated with said object.

19. The system according to claim 11, wherein said scene comprises an object that is moving toward a particular direction.

20. The system according to claim 19, wherein said one or more processors and/or circuits are operable to:
perform said security screening for said object for each of said captured plurality of 2D video image frames; and
identify said particular direction toward which said object is moving utilizing said captured corresponding depth information associated with said object.
